(19) United States
(12) Patent Application Publication
(10) Pub. No.: US 2017/0113446 A1
(43) Pub. Date: Apr. 27, 2017

(54) MANUFACTURING METHOD OF LARGE-SIZED TOUCH PANEL DEVICE

(71) Applicant: SMK Corporation, Tokyo (JP)

(72) Inventors: Tsutomu INOUE, Toyama (JP); Naomi NAKAYAMA, Toyama (JP)

(21) Appl. No.: 15/183,756

(22) Filed: Jun. 15, 2016

(30) Foreign Application Priority Data
Oct. 23, 2015 (JP) 2015-209398

(51) Int. Cl. B32B 37/10; B32B 37/14; B32B 38/00; B32B 37/12

(52) U.S. Cl. CPC B32B 37/1018; B32B 37/12; B32B 37/14; B32B 38/0008; B32B 2457/208

(57) ABSTRACT

The manufacturing method of a large-sized touch panel device by which a plurality of base materials different in linear expansion coefficient from each other is bonded together, includes: roughening the bonding surfaces of the base materials; and vacuum-bonding the base materials with an optical adhesive. The optical adhesive has a storage elastic modulus of 1×10⁵ Pa or more at 80° C.

### CROSS REFERENCE TO RELATED APPLICATION

The contents of the following Japanese patent application incorporated herein by reference,

Japanese Patent Application No. 2015-209398 filed on Oct. 23, 2015.

### FIELD

The present invention relates to a manufacturing method of a large-sized touch panel device.

### BACKGROUND

For example, JP 2012-33135 A discloses a capacitance touch panel device or the like in which a protective transparent base material formed of a glass base material or the like and a polymer film with a position detection electrode layer formed of a resin base material such as polycarbonate are bonded together with an optical adhesive.

When these base materials different in linear expansion coefficient are bonded together with an optical adhesive, air bubbles may be generated in the bonded portions or the optical adhesive may become soft and come off under high-temperature environments. This leads to deterioration in the quality of external appearance of the touch panel device.

In particular, this problem is more likely to occur with large-sized base materials that measure seven inches or more.

### SUMMARY

An object of the present invention is to provide a manufacturing method of a large-sized touch panel device that is effective in improving the bonding quality of a plurality of base materials largely different in linear expansion coefficient.

A manufacturing method of a large-sized touch panel device according to an aspect of the present invention is a manufacturing method of a large-size touch panel by which a plurality of base materials different in linear expansion coefficient from each other is bonded together, including roughening the bonding surfaces of the base materials and vacuum-bonding the base materials with an optical adhesive, wherein the optical adhesive has a storage elastic modulus of 1×10⁵ Pa or more at 80° C.

The large-sized touch panel device herein represents a touch panel sensor measuring seven inches or more.

The base materials different in linear expansion coefficient from each other have an expansion difference therebetween that becomes too large to ignore when the operating temperature of the touch panel device reaches as high as 50° C. or more.

For example, the glass base material has a linear expansion coefficient of 5×10⁻⁶ to 10×10⁻⁶ m/m° C., for example.

Meanwhile, the resin base material has a higher linear expansion coefficient: polycarbonate (PC): 70.0×10⁻⁶ m/m° C.; polyethylene terephthalate (PET): 60.0×10⁻⁶ m/m° C.; methacryl resin (PMMA): 70.0×10⁻⁶ m/m° C.; polypropylene (PP): 110×10⁻⁶ m/m° C.; and polyimide (PI): 54.0×10⁻⁶ m/m° C.

Accordingly, the glass base material and the resin base material have a difference in linear expansion coefficient of 40×10⁻⁶ m/m° C. or more therebetween. The difference in expansion therebetween cannot be ignored under high-temperature environments.

The optical adhesive plays a major role in assuring the bonding quality of the glass base material and the resin base material with such a large difference in linear expansion coefficient.

The optical adhesive is called optical clear adhesive (OCA), which is highly transparent and excellent in optical property.

In general, the OCA is hard at low temperatures and becomes soft at high temperatures.

However, when there is a large difference in linear expansion coefficient between the bonded base materials, the OCA becomes soft due to the difference in expansion between the base materials, to cause the bonded portions to separate from each other.

Therefore, an aspect of the present invention is characterized in using the OCA with a storage elastic modulus of 1×10⁵ Pa or more at a high temperature of 80° C.

Meanwhile, if the OCA has a high storage elastic modulus at room temperature, when there is a level difference in the bonded portions caused by prints or the like, the OCA fails to absorb the level difference and small air bubbles are prone to be left in the level-difference portion. The air bubbles become more prominent with gas expansion at higher temperatures.

The OCA preferably has a storage elastic modulus of 2.0×10⁵ Pa or less at 25° C.

The base materials are preferably vacuum-bonded under vacuum atmosphere (reduced-pressure atmosphere) to prevent the occurrence of air bubbles. The bonding surfaces of the base materials are preferably roughened for the purpose of improving the adherence of the OCA and the print inks.

The surfaces of the base materials are roughened by UV cleaning, corona discharge treatment, plasma treatment, or the like, for example.

To make a print on the bonding surface of the resin material for the purpose of decoration, the thickness of the print is set to 10% or less of the thickness of the OCA, so that the OCA can easily absorb the level difference of the print and allow the base materials to be bonded together with no small air bubbles left.

The resin base material may have a hard coat layer to prevent generation of a gas from the bonding surface.

When a sensor unit for capacitive touch panel is provided on the glass base material, a deflection plate may be laid on the lower surface of the glass base material.

According to the manufacturing method of a large-sized touch panel of the aspect of the present invention, the optical adhesive with a storage elastic modulus of 1×10⁵ Pa or more at a high temperature of 80° C. is used to bond together the base materials different in linear expansion modulus, thereby to obtain a high-quality touch panel device without occurrence of air bubbles or separation under high-temperature environments.

### BRIEF DESCRIPTION OF DRAWINGS

FIG. 1 illustrates an example of structure of a touch panel device according to an embodiment of the present invention.

### DESCRIPTION OF EMBODIMENTS

A large-sized touch panel device was prototyped using the manufacturing method according to an embodiment of the present invention and evaluated as described below.

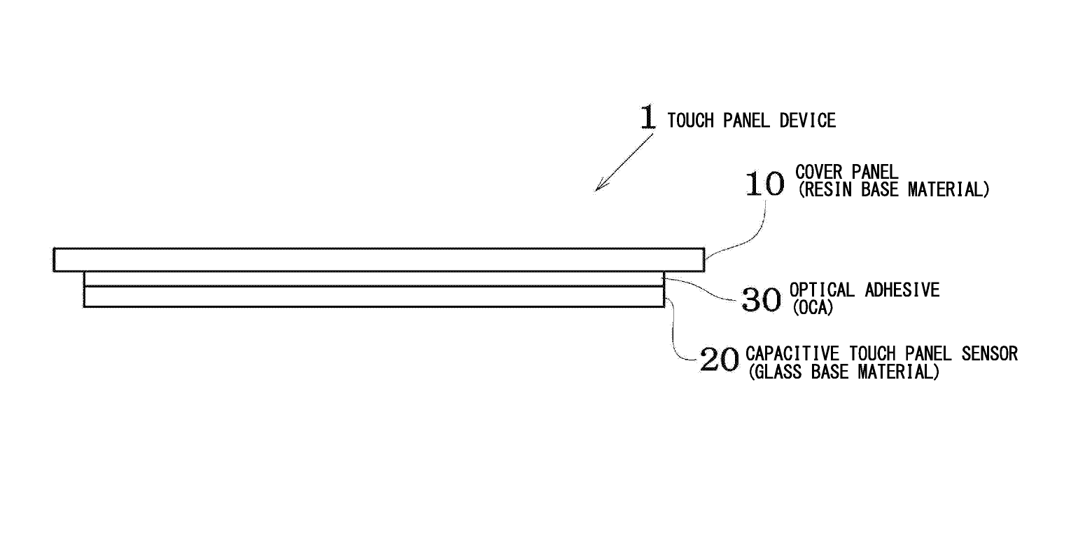

The prototyped touch panel device 1 was configured such that a polycarbonate cover panel 10 with a linear expansion coefficient of about 70×10⁻⁶ m/m° C. and a capacitive touch panel sensor 20 using a glass base material with a linear expansion coefficient of about 8.5×10⁻⁶ m/m° C. were bonded together with an optical adhesive (OCA) 30, as illustrated in FIG. 1.

The size of the capacitive touch panel sensor 20 was 11.7 inches, and the size of the cover panel 10 was slightly larger to cover fully the capacitive touch panel sensor 20.

For the bonding, the bonding surfaces of the cover panel 10 and the capacitive touch panel sensor 20 were UV-cleaned and bonded together with the OCA under vacuum atmosphere.

The OCA 30 had a storage elastic modulus of 1.4×10⁵ Pa at 25° C. and 1.0×10⁵ Pa at 80° C.

Thus obtained touch panel device 1 was subjected to heat cycle testing at 85° C. to −40° C. for a predetermined period of time and was found to maintain favorable appearance quality without occurrence of air bubbles or separation.

As a comparative example, a similar touch panel device was produced by the use of an OCA with a storage elastic modulus of 0.9×10⁵ Pa at 80° C. and was subjected to heat cycle testing under the same conditions. The comparative example was found to cause separation.

1. A manufacturing method of a large-sized touch panel device by which a plurality of base materials different in linear expansion coefficient from each other is bonded together, the method comprising:
roughening the bonding surfaces of the base materials; and
vacuum-bonding the base materials with an optical adhesive, wherein
the optical adhesive has a storage elastic modulus of 1×10⁵ Pa or more at 80° C.

2. The manufacturing method of a large-sized touch panel device according to claim 1, wherein the optical adhesive has a storage elastic modulus of 2.0×10⁵ Pa or less at 25° C.

3. The manufacturing method of a large-sized touch panel device according to claim 1, wherein the base materials are a resin base material and a glass base material in combination.

4. The manufacturing method of a large-sized touch panel device according to claim 3, wherein the resin base material constitutes a cover panel and the glass base material constitutes a sensor unit in a capacitive touch panel.

5. The manufacturing method of a large-sized touch panel device according to claim 1, wherein the roughening is any of UV cleaning, corona discharge treatment, and plasma treatment.

6. The manufacturing method of a large-sized touch panel device according to claim 3, wherein
the resin base material has a print on the bonding surface side, and
the thickness of the print is set to 10% or less of the thickness of the optical adhesive.

7. The manufacturing method of a large-sized touch panel device according to claim 3, wherein the resin base material has a hard coat layer on the bonding surface side.
